(19) United States
(12) Patent Application Publication
(10) Pub. No.: US 2002/0038178 A1
(43) Pub. Date: Mar. 28, 2002

(54) Golf navigation appliance

(76) Inventors: Andrea Talkenberg, Hamburg (DE); Herwarth Talkenberg, Hamburg (DE)

Correspondence Address: Barry E. Bretschneider, Morrison & Foerster LLP, Suite 5500, 2000 Pennsylvania Avenue, N.W., Washington, DC, 20006-1888, US

(21) Appl. No.: 09/945,562

(22) Filed: Sep. 5, 2001

Related U.S. Application Data
(63) Continuation of application No. PCT/EP00/01926, filed on Mar. 6, 2000.

(30) Foreign Application Priority Data
Mar. 5, 1999 (EP) 99 104 494.2

(51) Int. Cl. G01C 21/26

(52) U.S. Cl. 701/200; 701/213

(57) ABSTRACT

Navigation appliance for determining and indicating the position of a pedestrian, in particular a golfer on a golf course, which appliance is portable and has a navigation device, a memory device, an input device and a display device which are connected to an arithmetic device, where the navigation device comprises a relative-position determination device which has a motion sensor and is designed to estimate a distance covered on foot by the golf player. The invention also extends to a method for navigation using a relative-position determination device, having the following steps: measurement of acceleration values using a motion sensor arranged on a pedestrian, in particular on a golf player; storage of the acceleration values over a time period; and calculation of walking speed and/or distance walked for the user using an estimation model. The invention also relates to a method for navigation in a golf game with reading and display of a sample game progression.

### REFERENCE TO RELATED APPLICATION

This application is a continuation of International Application No. PCT/EU00/01926, filed Mar. 6, 2000, which claims priority from European Application No. 99 104 494.2, filed Mar. 5, 1999.

### FIELD OF THE INVENTION

The invention relates to a navigation appliance for determining and indicating the position of a pedestrian and, in particular a golf player on golf course, which appliance is portable and has a navigation device, a memory device, an input device and a display device which are connected to an arithmetic device, the navigation device comprising a relative-position determination position device having a motion sensor which produces measurement data.

### BACKGROUND OF THE INVENTION

An orientation appliance having an input device, a display device, a memory device and an arithmetic device connected to the aforementioned devices is described in WO 96/22132. The memory device stores geographical features of the golf course. The appliance is in the form of a range finder and, following manual entry of the position, determines the distance to a selectable geographical feature of the golf course, for example to the pin on a hole or to any other obstacle.

U.S. Pat. No. 5,245,537 discloses a golf navigation appliance which has an input device, a display device, a memory device and an arithmetic device. The arithmetic device is connected to two linear acceleration sensors and an angle acceleration sensor and is used for ascertaining the movements of a golf player carrying the golf navigation appliance. The navigation principle is based on twice integrating, in a manner known per se, the accelerations ascertained by the linear acceleration sensors in order to obtain distances, and adding these distances taking into account the respective direction taken, which is determined from measurement data from the angle acceleration sensor. In this way, the current position of the golf player in relation to a starting point is ascertained. The appliance is thus a navigation appliance which determines the position of the golf player relative to a fixed point using dead reckoning. A drawback of this navigation appliance is that, by virtue of its principle, it suffers both from considerable measurement inaccuracies and from cumulative errors. The linear acceleration sensors allow accurate determination of the position only in the horizontal plane; any tilting out of this plane, whether as a result of inclined ground or as a result of the appliance itself being in an oblique position, results in measurement errors, because the acceleration due to gravity is then measured at the same time by the longitudinal acceleration sensors. On the basis of this incorrect measurement signal, the navigation appliance then ascertains a movement by the golf player which has not actually occurred. The position ascertained on the basis of this movement is thus incorrect. In addition, the method used by the arithmetic device, obtaining the distance from the signal from the longitudinal acceleration sensors using double integration, has the drawback that even small measurement errors add up to form large errors for the distance and hence for the position, with the size of the error continuously increasing over time. Together with the sensitivity of the known navigation appliance with respect to inclined surfaces, which make up a large part of the area on golf courses, this results in considerable inaccuracies in practical use.

A simple system for assisting a golf player in terms of orientation and logging is known from U.S. Pat. No. 5,319,548. The system comprises an arithmetic device having a map printer and a reading device. For each hole to be played, a map of this hole is printed out together with topographical features of the terrain and is provided for the golf player; in the course of the game, the golf player fills in this map by entering the respective shot location and the club used into the map; at the end of a game, the maps are read into the arithmetic device by means of the reading device and are evaluated. The shot locations to be entered into the map need to be determined by the golf player himself.

Portable navigation appliances are known which use a navigation system to determine a position of a player on a golf course and to display it on a graphical display device together with a selectable detail of a map of the golf course and with additional information, such as the distance to the target on the hole or to obstacles (U.S. Pat. No. 5,438,518, U.S. Pat. No. 5,810,680, U.S. Pat. No. 5,507,485). To determine the position, a satellite navigation receiver which uses the global positioning system (GPS) is preferably used. The golf navigation appliance in accordance with U.S. Pat. No. 5,438,518 has an exchangeable memory module which stores a digitized map of the golf course.

WO 96/21161 discloses a golf navigation system having a base appliance and a plurality of mobile appliances, the mobile appliances having a memory device, an input device, a display device and a navigation device which are connected to an arithmetic device. The memory device stores geographical features of the golf course including positions of the pins on the holes for the current day.

In addition, navigation systems for determining and indicating a position of a golf player on a golf course are known which comprise a base station, arranged at a fixed location, and one or more mobile stations (WO-A-98/05978, U.S. Pat. No. 5,689,431).

The mobile station is arranged in a golf vehicle. To determine the mobile station's position, besides a GPS receiver, an integrated navigation device is additionally provided which evaluates the distances covered by the golf vehicle and their direction. Information about the whereabouts of the golf vehicle is transmitted by radio to the base station, and information about the hole to be played is transmitted by radio from the base station to the mobile station. The mobile station has a display device which can show a selectable detail of a map of the golf course. The display device can also show other data, for example the distance to the target (pin). The mobile station can also be portable, so that the golf player can carry it with him and can also read the display in cases in which it would not be possible to read the display in the golf vehicle from the shot location.

A drawback of the known apparatuses is that the accuracy of the navigation and also the availability are inadequate. The GPS systems normally used as navigation device in the prior art are too inaccurate, on account of their limited resolution, to permit sufficiently accurate position finding over short distances too. This lack of accuracy becomes adversely noticeable particularly in the fine range of position finding, for example when putting. In addition, the accuracy of GPS is not constant, but instead may be additionally enhanced by signal variations, specifically without informing the user about this. Besides this, in particular on uneven terrain, as is typical for golf courses, signal interference may arise as a result of effects of shade, which further reduces the accuracy, which is already not high anyway, until navigation fails. Although it is possible to provide an external system, such as a reference station, in order to increase the accuracy, this is very complex and such a system is frequently not available on other golf courses, which restricts the ability of the navigation appliance to be used locally.

### SUMMARY OF THE INVENTION

According to the invention, in a navigation appliance of the type mentioned in the introduction, the relative-position determination device has a model-based pedometer which is designed to process the measurement data in a biomechanical model. In this context, a pedometer is understood to mean a relative-position determination device which, as described above, is designed to estimate a distance covered on foot by the golf player.

A biomechanical model is understood to mean a model in which the function of the human motion apparatus, in particular legs and hip, is implemented.

According to the invention, the estimator is designed to determine the distance covered on foot by the pedestrian on the basis of a model. This means that, to determine the distance, the estimator uses not just the measurement data from the motion sensor alone, but also particular programmed knowledge about the moving object (the pedestrian) in addition. The model of the estimator contains available knowledge about the anatomy and function of the human motion apparatus in mathematical form, specifically in the system equations of the model. This allows the knowledge about the moving object to be used, which would not be taken into account, and would thus remain useless, if the classical motion equations were used. In this case, the estimator can contain an entirely simplified model. Such a model-based estimator provides much better results than conventional calculations using classical motion equations, for example using double integration of the acceleration signal, specifically both from the point of view of accuracy and from that of robustness.

The motion sensor, which the invention arranges directly on the pedestrian (user), can easily and reliably ascertain the input signals required for the pedometer. This has the advantage that the position of the pedestrian is determined by means of integrated navigation (which for the purposes of this application includes, but is not limited to, dead reckoning), that is to say using a relative-position determination device and not using an absolute-position determination device, such as the GPS, which is too inaccurate in the fine range. The fact that, according to the invention, measured variables of the motion sensor are directly movements of the pedestrian means that his position is determined directly, and not just the position of an accompanying car, in particular of a golf vehicle carrying the user, as in the case of the integrated navigation known from U.S. Pat. No. 5,689,431. In accordance with the invention, it is thus no longer necessary to use wheel sensors for distance measurement, said wheel sensors being arranged on a wheel which is with the user, e.g. on a golf vehicle or on a golf trolley, and thus ultimately permitting only the position of the wheel to be determined. This is particularly advantageous on golf courses whose landscape design make them less suitable for driving on or else which, for example on account of severe gradients or drops, are not suitable for bringing along golf trolleys.

A few terms used will be explained below:

A motion sensor is understood to mean a sensor which is such that it directly records the movements of an object connected thereto, in particular an acceleration or vibration sensor.

A memory device is understood to mean a device for storing data. The term includes both permanently installed memory devices and exchangeable memory devices, called memory chip or memory module below.

A navigation device is understood to mean a device which uses data obtained from sensors to ascertain the current position at which the golf navigation appliance or the golf player is located.

An arithmetic device is understood to mean a device in which data are processed. This also includes reading and writing and also displaying data.

A game progression is understood to mean a set of positions on the golf course which have been adopted by the golf player in the course of a round on the holes of the golf course.

An actual game progression is understood to mean a game progression in the current or in a preceding game, which game progression is written to the memory device during a game.

A sample game progression is understood to mean a game progression which is stored in the memory device irrespective of the user and serves as a reference.

A club type is understood to mean a golf club from a set of different golf clubs, for example 5 iron or 6 wood.

Shot data are understood to mean information relating to the shots, for example the location of the shot and the club type.

An absolute position is understood to mean a position which can be determined without knowledge of a preceding position.

A relative position is understood to mean a position whose determination requires knowledge of a preceding position.

An estimator is understood to mean a special arithmetic device which uses an internal model to ascertain a value for an unmeasured parameter from other measured parameters.

A pace detector is understood to mean a device for determining an event of a pace (pace event) when walking, for example the placement of a foot.

A cycle time is understood to mean the time period required for one pace, said time period being determined by two directly successive pace events.

The motion sensor is advantageously in the form of an acceleration sensor.

It is expedient if the acceleration sensor is set up to measure in two directions, in particular in the longitudinal direction and in the vertical direction. This provides measurement data in two mutually independent directions; this is advantageous for evaluation, because this also permits calculation of cross-correlations, in particular. The measurement data for acceleration in the vertical direction allow the use of a calculation method for estimating the distance covered on foot, which requires no double integration of horizontal acceleration values, as is otherwise usually used.

The motion sensor is expediently arranged in the area of the pedestrian's pelvis. This is based on the insight that there is a relationship between the motion of the human body, in particular of particular elements of the human motion apparatus, and parameters of walking, for example walking speed. This results, in particular, from the effort of the human organism to minimize the energy required for the respective state of walking.

Expediently, the relative-position determination device has at least one further motion sensor, which is arranged at a physically separate point and preferably has a wireless transmission device. In this context, not all of the further sensors need to be arranged separately; it is also possible for some to be arranged on the navigation appliance and some externally. The motion sensor can also be arranged directly on the pedestrian, e. g. on a golf player and the navigation appliance separately, e.g. on a golf trolley. Conversely, the further sensors can be arranged on the golf vehicle or on the golf trolley and can transmit measurement signals wirelessly to the golf navigation appliance carried by the golf player. In this case, the position-measurement device can be in the form of a simple sensor scanning the revolution of a wheel on the golf vehicle or on the golf trolley. It is particularly expedient for it to be in the form of an inductively operating sensor which additionally provides electrical power on the basis of the dynamo-electrical principle. The transmission device can transmit signals measured by the sensors or, in connection with an arithmetic device likewise arranged externally with the sensors, can transmit position data to the golf navigation appliance; the slight drawback of the additionally necessary arithmetic device is contrasted by the advantage of a much lower bandwidth requirement. In addition, the robustness with respect to transmission interference is greater, since interference in the transmission of signals from the position-measurement device results in corruption of the distance, which impairs the accuracy of the relative positions subsequently ascertained by integrated navigation, while, in the case of interference in the transmission of a position statement, only this statement is incorrect and the subsequent ones are valid again (knowledge thereof can then be used to detect and eliminate the incorrect position statement).

Expediently, a sensor arranged at a physically separate point has an identification feature which can be transmitted by the transmission device. Such an identification feature has the advantage that measurement data transmitted to the golf navigation appliance by the transmission device can be associated with the respective sensor by virtue of the identification feature. This is particularly significant if game progressions for a plurality of pedestrians or golf players are to be recorded by one (golf) navigation appliance, since the respective position data for the individual players can then be associated with them.

Expediently, a compensation device for sensors of the relative-position determination device is also provided which compensates for measurement errors arising as a result of inclination, in particular. This is particularly advantageous for an angle-measurement device of the relative-position determination device. This is because this relative-position determination device normally has an angle-measurement device besides the position-measurement device. These two measurement devices can be used by the relative-position determination device to perform integrated navigation in a manner known per se. The angle-measurement device is expediently a compass sensor which indicates the current direction in relation to the direction of magnetic north. To compensate for locally different declinations, for example as a result of cables laid in the ground, the map expediently stores additional information relating to the local declination. To save memory space, the additional information is advantageously stored as isogons.

As a simple general case, the following entries are provided in the digital map, in a fashion comparable to marine maps: declination on a given date, annual change in the declination.

In one advantageous embodiment, the navigation device has an absolute-position determination device besides the relative-position determination device. Combining these two determination devices has the advantage that position data ascertained independently of one another are available. Besides a greater level of reliability of position determination on account of this redundancy, data merging also allows a greater level of accuracy to be achieved. The absolute-position determination device allows the position data ascertained by the relative-position determination device to be verified and possibly corrected as required. The relative-position determination device means that the availability of the position data is always assured, specifically even in cases in which the absolute-position determination device is not working. This combines the advantages of the two position-determination devices: data merging allows the high level of long-term accuracy of an absolute-position determination device to be linked to the good fine-range resolution of a relative-position determination device.

Expediently, the absolute-position determination device is a receiver which is suitable for receiving signals from the satellites of the global positioning system (GPS). The receivers can be obtained commercially at reasonable cost. It is particularly advantageous if a receiver which is suitable for differential GPS (DGPS) is used, because this, together with an appropriate reference station emitting differential signals, allows a much higher level of position-determination accuracy to be achieved as compared with the normal GPS. The reference station is normally arranged in the clubhouse of the golf club. However, it is not absolutely essential for the DGPS receiver that a reference station always be available; if there is not one, then it works like a conventional GPS receiver.

Another option for absolute-position determination is to take a bearing for terrain markers whose location is known, particularly when using the method of taking a cross-bearing. The term “taking a cross-bearing” denotes finding the bearing of two landmarks from the same direction-finding location. The point of intersection of the ascertained lines of position is the location of the observer (direction-finding location). Such taking of a cross-bearing can be implemented with little effort using the inventive (golf) navigation appliance, since landmarks whose bearing can be found are stored in the digitized golf course map.

Preferably, the memory device stores a sample game progression and/or a digitized golf course map. This has the advantage that the sample game progression can be read from the memory device and displayed, which gives the golf player an opportunity to compare his game and the game represented by the sample game progression. Expediently, the sample game progression is a game progression with a model character, such as has been played by a golf instructor or by a professional player on the respective course. This has the advantage that a pre-programmed sample game progression provides a reference game progression which is independent of the golf player using it and of his game efforts and which provides the player with the option of targeted and hence simpler learning.

Advantageously, the memory device comprises an exchangeable memory module which stores the digitized golf course map and/or the sample game progression. This means that, by simply interchanging the memory module, it is possible to provide a different sample game progression, e.g. a sample game progression with a more demanding game in line with increased skills of the golf player. The fact that the digitized golf course map is stored in the exchangeable memory module means that changing to a different golf course by simply interchanging the memory module allows the golf navigation appliance to be provided both with an appropriate golf course map and with a reference game progression associated with this golf course.

Naturally, it is not imperative to store just one sample game progression, but rather a number of sample game progressions can also be stored for one golf course or else for a number of golf courses. Thus, for example, various sample game progressions can reflect different degrees of difficulty, which means that the golf player has a suitable sample game progression available as a standard according to his ability and learning progress. The fact that the sample game progressions can also relate to different golf courses means that, initially, it is possible to use a sample game progression on a simple golf course, and, when the ability of the golf player has improved, it is possible to use one on a more difficult golf course as a standard. The inventive apparatus is thus a valuable means, both for beginner and advanced golf players, to achieve further learning progress and/or to introduce them to unknown golf courses with their local peculiarities. The stored sample game progression as the standard shows up strengths and weaknesses of the golf player.

This also has the advantage that the golf player using it can have a kind of competition against the reference, that is to say against the real or idealized golf player whose game progression is stored in the memory device as the sample game progression.

The golf course map can be stored in the memory device in any digitized form. Advantageously, it contains height information; in this case, it is referred to as a three-dimensional map. The statements relating to height can be stored both with a relative reference to a reference point or with an absolute reference to the zero norm. The golf course map can also contain statements relating to the height of obstacles. The golf course map can also contain further information, for example the respective local magnetic declinations for the area shown on the golf course map. The golf course map is advantageously stored in a format which saves memory space, for example in the form of a vector map.

Expediently, the memory device stores an actual game progression with path data for the golf player and additional information, in particular shot data. Besides shot data, the additional information can also comprise further values, for example wind information such as wind strength and wind direction. In this way, the golf navigation appliance replaces logging equipment which has normally been used up until now, such as cards for entering the number of shots or conventional shot counters; it also provides additional functions.

Expediently, the display device can selectively show a selectable area of the golf course map, the sample game progression, an actual game progression and/or the distance and direction to a target. To be able to show an area from the golf course map, the display device expediently has a graphics capability. Normally, the selected area of the golf course map is then shown as the background, and the current actual game progression and the sample game progression are shown additionally. One area of the display device also shows statements relating to the distance and/or direction to the target. The target is generally the pin on the hole being played, the position of which can also be shown by the main focus of the surface of the green. The distance and/or direction to a freely selectable auxiliary target, for example a distinctive point on the landscape or an obstacle, can also be shown.

Advantageously, a comparison device is provided for comparing an actual game progression with another game progression or with the sample game progression. Game progressions can be compared and shown in terms of the path taken and in terms of the additional information, for example in terms of the number of shots required. Advantageously, the golf navigation appliance has a chronometer. In this case, the comparison device can also include time-dependent data, for example time period required for playing a hole or for the entire round.

In accordance with another advantageous development, the golf navigation appliance comprises a wind-measurement device. The ascertained wind data, in particular wind speed and wind direction, are supplied to the arithmetic device and can be used for calculations and can be stored as additional information with the actual game progression. However, it is also possible to provide for the wind data to be entered by the user using the input device.

In accordance with another advantageous embodiment, the inventive appliance has an input device for marking a current ball position. For this purpose, a particular position can be marked on the golf course map and the appliance can be informed, for example by sensor or by button entry, that the ball was or is at this position at a particular time. This function allows shots to be entered retrospectively if the golfer has forgotten upon the actual shot to “inform” the appliance that a shot is being taken. This function can also be useful for absolute-position determination when a reliable absolute-position determination method such as DGPS is not available. In this case, whenever the ball is situated at or close to a landmark shown on the map, the player can record this position and mark it as the current ball position. The appliance then has a new starting point from which further integrated position-finding can be carried out, for example. The input device expediently comprises a keypad for entering data, for example shot data, and a cursor rocker, for example for selecting a target.

The invention also extends to a method for navigation in a golf game, having the following steps: an area of a digital golf course map is read from a memory device, a selection option is offered between at least one sample game progression and/or an actual game progression stored in the memory device, a sample game progression is read from the memory device, the current position is determined using a navigation device, an actual game progression is stored in the memory device, and the actual game progression is displayed and/or compared with the selected game progression. Said steps of the method do not necessarily have to be performed in the stated order, for example an actual game progression can also be stored right at the end. The current position is expediently displayed continuously until a target or the end of the game has been reached.

The inventive method has the advantage that by virtue of reading and display and also possibly comparison with the sample game progression as reference, the golf player is provided with the opportunity to compare his current game or a previous game (actual game progression) with the reference (sample game progression). This allows the golf player to analyse his game technique, in particular in difficult sections, taking into account his own previous actual game progressions and the sample game progression; reproduction of his own, previous actual game progressions has the advantage that the golf player recognizes sections in which he repeatedly makes the same errors, and sees how he can use the sample game progression to improve his technique. The inventive method also provides the option of a virtual competition. In this case, the display device shows the current game of the golf player using the inventive equipment, that is to say the actual game progression, and, as a comparison for this, a previous actual game progression, which can come from the same golf player or from a club companion, or the sample game progression. This makes it possible to have a kind of virtual competition with another golf player who is absent. If the sample game progression is a game from a known professional golfer, then the player can attempt to imitate such a “famous” game.

Expediently, the method involves requesting the touch of a button at the location of the shot (shot location). Pressing this button means that, firstly, the current position is assumed as the position of the shot location, and, secondly, a counting device for the number of shots is incremented by 1. This request is advantageously connected to a request for a club type. This has the advantage that, particularly for later statistical evaluations, the information is available regarding which club was used to play a particular shot.

Preferably, the method also involves requesting a number of golf players and storing the respective actual game progressions in an associated area of the memory device. This has the advantage that the game progressions for a plurality of players can be logged without the need for relatively complicated counting cards, which are also susceptible to error when they are dealt with. Such reliable, automatic logging is particularly advantageous for competitions.

Expediently, the method involves storing path data and additional information, in particular shot data, in that area of the memory device which is associated with an actual game progression. Storage means that a wealth of information is available which is used by advantageous developments of the inventive method which are described in the text below.

Expediently, the method involves requesting or selecting a target and displaying the distance to the target. The distance to the target on the hole is calculated and displayed. The target is generally the pin on the respective hole being played; to determine the pin, it is not absolutely necessary to use the coordinates of the current position of the pin, but rather the main focus of the surface of the green can also be used for the purposes of determination. The selection can be made manually or automatically by determining the hole which is to be played currently using the current position and reading the coordinates of the target. Expediently, the direction to the target is also calculated and displayed; this is particularly advantageous for holes comprising angles. This allows the golf player to determine the distance to the target reliably without him depending on any auxiliary means which may be provided on the golf course, such as distance tables. Knowledge of the distance to the target is important particularly in order to allow the golf player to select the correct club from the set of golf clubs.

Expediently, provision is also made for an auxiliary target to be requested and for the distance to this target to be calculated and possibly displayed. The reason for this is that a golf player is frequently interested not only in the distance to the pin, but also in the distance to an obstacle, such as an area of water or a bunker. Expediently, the user requests the auxiliary target by using the input device to move a cursor on the golf course map shown to the point of interest and to mark this as the auxiliary target; from this and from the current position, the distance and possibly the direction are then calculated and displayed.

Expediently, provision is also made for the wind conditions to be requested or to be read in by the wind-measurement device. This is particularly expedient for correcting measured shot distances, in particular when these are used for statistical purposes or for predicting a shot distance which can be expected with a particular club type.

Advantageously, provision is also made for a plurality of actual game progressions to be stored and collected in at least one area of the memory device. Such an area of the memory device intended for this purpose is called a data pool. Expediently, a plurality of data pools are provided. The data about a selectable time are collected and stored in an interval-related data pool. This allows the golf player to document his games for one day, for example; a longer time period can also be chosen, however, so that the player can document progress or regression in his playing technique. Optionally, the player can mark his best game on a particular course and keep it for subsequent retrieval.

It is also advantageous to collect and store the shot data for a plurality of shots from a golf player in a player-related data pool. The shot data include, in particular, the type of club used and the distance achieved; if appropriate, it is also possible to store the respective wind conditions at the same time or else to correct the values to be stored immediately using a correction factor ascertained on an appropriate basis from the wind conditions. Collecting these data has the advantage that it is possible to produce for a player statistical characteristic quantities for the shot distance on the basis of the individual club types. The statistical characteristic quantities include, in particular, mean values, standard deviations and also maximum and minimum values.

Expediently, provision is also made for the respective actual game progressions played on a golf course to be collected and stored in a golf-course-related data pool. This has the advantage that the game progressions obtained by a player on various golf courses and the results can be stored and retrieved independently of one another. During a subsequent visit to a golf course which has already been played, for example, the player can retrieve the data for a previous game. This is particularly significant for the shot data stored in relation to the respective club type, because, according to the local circumstances, one and the same club type can produce entirely different shot distances, for example as a result of a different nature of the soil. In this way, the experience already gained with a particular club type on a particular golf course can be used.

Expediently, provision is made for the collected shot-related data to be used to calculate a prediction for a shot distance which can be expected with a club type. If available, the wind conditions are also expediently taken into account in this context. In addition, it is expedient to read other topological features from the golf course map and to include them in the calculation; this is particularly true for height differences when, by way of example, a shot is being taken from a higher location. Particularly for less experienced golf players, it is advantageous if the shot distances which can be expected are calculated and displayed for different club types. Other topological features possibly to be taken into account in the calculation are the height of obstacles and the nature of the soil, for example. In this context, it may be expedient if obstacle data, in particular, are read from the digitized golf course map, and particular club types are marked as less recommended, for example if their shot distance can be expected to result in the golf ball landing in the area of an obstacle.

Advantageously, the arithmetic models used for calculation are modified by evaluating at least one data pool. By way of example, this can be used to adjust the shot distance's values calculated as part of the prediction if the statistical evaluation reveals that the average shot distances attained differ from the predicted ones on average; this can be significant particularly if other clubs than the familiar ones are being used or if there are changes about the golf player's person, such as a hand injury.

Expediently, the method involves carrying out data merging for absolute and relative position data. As already mentioned, this can increase both the accuracy and the reliability of navigation.

Expediently, a starting point and an ending point for at least part of a game progression are ascertained using relative or absolute position data and are stored, the difference from a known position for the ending point is determined and parameters for integration are modified. This allows errors or discrepancies in the method for calculating the integrated navigation to be reduced. Expediently, correction is carried out only if the difference is above a particular maximum permissible magnitude of error. The corrected parameters for integration are expediently determined using a compensation calculation. In this context, in particular, a correction factor for ascertaining the distance and a zero-point discrepancy for the compass device are determined. Expediently, a calibration mode is provided for this purpose. This involves a request for an orientation point, determination of a direction to the orientation point, determination of the direction measured by the compass device for a user looking toward the orientation point, ascertainment of the angle difference between the directions, and storage of this angle difference for correcting the measured values of the compass device. Performing these calibrations has the advantage that the method for determining the relative position is improved in a self-learning manner to some extent, and thus permits improved position determination.

Within the context of calibration of the compass device, it is possible with little additional effort to ascertain a cross-bearing for known landmarks for ascertaining an absolute position as the starting point for subsequent integrated navigation. For this purpose, a first landmark (for example the flag of the pin) is selected on the screen of the golf navigation appliance using a cursor function. The user then orientates himself and the navigation appliance to this landmark. If appropriate, the appliance can have an optical direction-finding device for this purpose. When orientation is complete, the bearing is stored by pressing a button or the like. Preferably, the measured line of position appears on the screen. In accordance with the same method, a second known landmark is then selected and a bearing is taken for it, the second line of position being at right angles to the first line of position as far as possible in order to minimize the bearing errors. The golf navigation appliance ascertains the current position from the point of intersection of the two lines of position.

Such position-finding can be advantageous particularly if another sufficiently accurate absolute position-finding method, such as differential GPS, is not available and exclusive integrated position-finding starting from the shot is too inaccurate, for example on account of the fact that the player goes round in a large number of loops searching for the ball after a shot into the rough. Integrated position-finding can also be inaccurate or impossible if the player is using a golf cart or alternately covers distances on foot and using the golf cart. A cross-bearing can then be taken as required to ascertain a new absolute position as the starting point for further integrated navigation.

In accordance with another aspect of the invention, a method for navigation using a relative-position determination device is provided, comprising the following steps: measurement of acceleration values using a motion sensor arranged on a pedestrian, in particular on a golf player, storage of the acceleration values over a time period, and calculation of walking speed and/or distance walked by the pedestrian using an estimator, where the estimator used is a biomechanical model of the human motion apparatus. This method is suitable, particularly advantageously, for determining the relative position in the navigation method described above. It has the particular advantage that the distance covered can be determined, as is necessary for carrying out integrated navigation using relative-position determination, by means of a measurement directly on the body of the golfer. According to the invention, it is no longer necessary for the purposes of path measurement to have recourse to wheel sensors which are arranged on a wheel accompanying the pedestrian user, e.g. on a golf vehicle or on a golf trolley, and thus ultimately only allow the position of the wheel to be determined. It has been recognized that there is a relationship between the movement of the human body and parameters of walking, for example walking speed. This relationship results particularly from the effort of the human organism to minimize the energy required for the respective state of walking. This avoids the drawback of the normal method of calculating the speed or distance from single or double integration of the acceleration values in the horizontal direction over time, namely that a low level of accuracy is achieved particularly on inclined ground. In contrast to this, the method claimed uses the measured acceleration values essentially as motion signals; the aforementioned relationship between required energy of motion and walking speed or distance walked is implemented in the inventive estimation model. The method also has the advantage that the essentially dynamic motion signals mean that statically active interference variables, such as inclined ground, are not significant or have only reduced significance and, furthermore, can easily be isolated and ascertained from the measurement signals.

Advantageously, the method involves measuring the acceleration in two independent directions, in particular longitudinal and vertical accelerations. The resultant measurement data from two independent directions are advantageous for evaluation, particularly when cross-correlations are calculated.

The method for calculating the walking speed or distance walked preferably involves a first polynomial rule with a correlation of variances in the acceleration values for calculating the walking speed or the pace length. Preferably, the variances in the vertical acceleration over one pace are correlated. For calculating the walking speed, a polynomial of second or higher order is normally suitable, and a 1st-order polynomial is adequate for calculating the pace length. Expediently, the method involves determining a cycle time for one pace. This is significant particularly for estimating a pace length, since walking speed and pace length are linked to one another over the cycle time. Thus, the method expediently calculates an estimated value for the pace length from a mean value for the walking speed and the cycle time. It may be advantageous if a mean pace length is calculated by averaging the pace lengths of both legs.

Expediently, the method also involves estimating an inclination for the distance walked, in particular by using a second polynomial rule by correlating mean values for the acceleration values. Preferably, the mean value for the vertical acceleration is correlated. The distance covered on the level can be calculated from the inclination and the distance covered, in particular by multiplication by the cosine of the angle of inclination; this is particularly significant for integrated navigation. Ascertaining the inclination of the distance walked thus allows a significant increase in the accuracy of integrated navigation.

In another advantageous embodiment, the method involves estimating a staircase inclination and a standard step length by using the mean values and variances in the acceleration values. Taking into account a standard step length bears in mind the fact that staircases usually comprise an arrangement of steps with a fixed step height and step length. Since the standard step length can be calculated from more measurement data than would be possible for individual steps, the calculation is more accurate; in addition, errors resulting from different lengths of individual steps are eliminated.

Expediently, the method involves detection of walking/running. This is important because models for estimating distance walked and walking speed are frequently not suitable for estimating running motions. To prevent the results of the walk-estimator model from being corrupted without recognition on account of running motions, it is beneficial if the method detects the type of motion. If a running phase is recognized, then it is possible to change over to a special running estimation model, or at least walking estimation can be discontinued and a warning can be output to the user. This can prevent self-adapting parameters from being mismatched on account of running. For any new determination of the integrated position which may be required at the end of a running phase, the absolute-position determination device, e.g. the direction-finding described, is expedient.

Walking is understood to mean a type of motion for which there is a phase during which both feet touch the ground at the same time (“double-stance phase”). Running is understood to mean a type of motion for which this phase is replaced by a phase of flight.

One expedient method for detecting running/walking is to calculate the variances in the acceleration values, in particular over the cycle time, and to compare them with previous values for the variance. Preferably, the values for the variance are processed in advance using a smoothing method. Another expedient method is to determine ranges of the values for the acceleration. This is based on the insight that the range for running is considerably greater than for walking. It is frequently sufficient not to determine the type of motion directly, but instead to detect only a change. The aforementioned methods then need to ascertain only an abrupt change in the respectively relevant parameter. An abrupt rise is a sign of changing over to running; accordingly, an abrupt drop is a sign of changing over to walking.

Another expedient method for detecting running/walking is to calculate a power density spectrum for an acceleration and to determine whether an ancillary maximum is available. This is based on the insight that the human motion apparatus is designed such that the greatest possible efficiency is achieved for moving along. This means that, for walking, reduction of the metabolic effort is in the foreground, whereas, for running, this aspect becomes less important in favour of a speed aspect. The invention has recognized that acceleration values are able to determine whether or not the pelvis is making movements to reduce the metabolic effort. One preferred parameter for this is the power density spectrum of an acceleration direction, in particular whether this contains a significant ancillary maximum besides a primary maximum.

A tried-and-tested parameter for the aforementioned methods for detecting walking/running is acceleration in the vertical direction; other acceleration directions can also be used, however.

Advantageously, the method also involves detecting a shot from the acceleration values in order to determine the shot location. If a shot is recognized, the current position data ascertained by the navigation device are stored as the shot location. This has the particular advantage that the user is freed from entering the shot location, for which the touch of a button is otherwise necessary at the respective shot location, because the shot can be detected from the acceleration values, with the current position in this case being stored as the position for the shot location. This eliminates entry of the shot location, which is complex and easy to forget; automated counting of the number of shots also becomes more reliable as a result.

It goes without saying that the invention can advantageously also be used for users other than golf players, and it is not limited to golf players as users.

### BRIEF DESCRIPTION OF THE DRAWINGS

An exemplary embodiment of the invention is explained by way of example below with reference to the figures of the appended drawing, in which:

FIG. 1 shows a block diagram of the inventive appliance;

FIG. 2 shows a schematic view of an area of a golf course with the inventive appliance and components of the GPS system;

FIG. 3 shows a view of the front of the inventive appliance;

FIG. 4 shows a view of the back of the inventive appliance;

FIG. 5 shows a block diagram of a sensor arrangement;

FIG. 6 shows a block diagram of an alternative sensor arrangement;

FIG. 7 shows a flowchart for the inventive method;

FIG. 8 shows a flowchart for an operating mode of the inventive method;

FIG. 9 shows a flowchart for another operating mode of the inventive method;

FIG. 10 shows a flowchart for calibration of the integrated position-finding;

FIG. 11 shows a flowchart for the walk-estimator for determining the cycle duration;

FIG. 12 shows a flowchart for the walk-estimator for determining cyclic parameters;

FIG. 13 shows a graph containing values for variances in the vertical acceleration over walking/running speed;

FIG. 14 shows graphs containing values for power density spectra for vertical accelerations;

FIG. 15 shows a flowchart for the walk-estimator for determining the distance;

FIG. 16 shows a flowchart for calibration of the compass; and

FIG. 17 shows a display on the display device in the calibration mode.

### DETAILED DESCRIPTION OF THE INVENTION

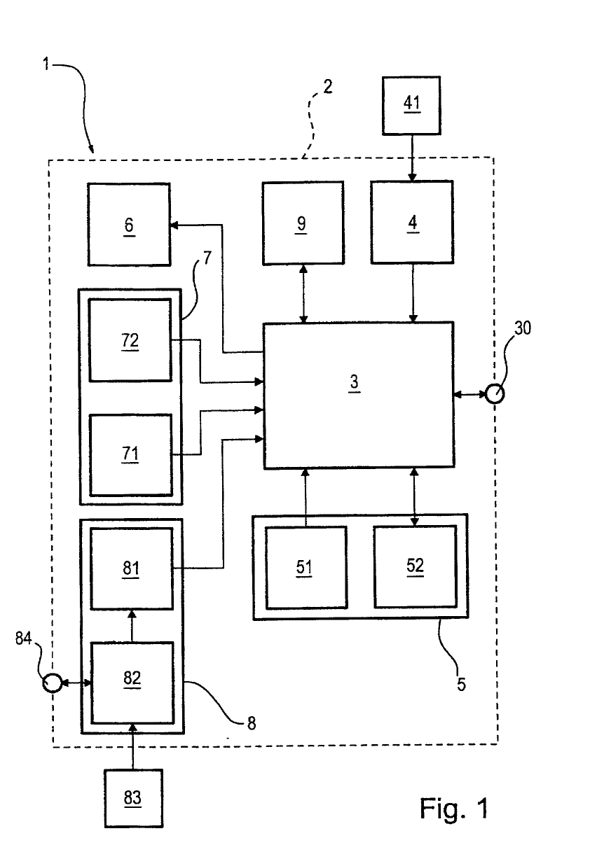

FIG. 1 shows an exemplary embodiment of a central unit 1 of the inventive golf navigation appliance. The central unit 1 shown contains, in a main housing 2, an arithmetic device 3 and, connected thereto, a GPS receiver 4, a memory device 5, a display device 6, an input device 7, a power supply device 8 and a radio modem 9 as transmission device. The central unit 1 can optionally have a data transmission connection 31.

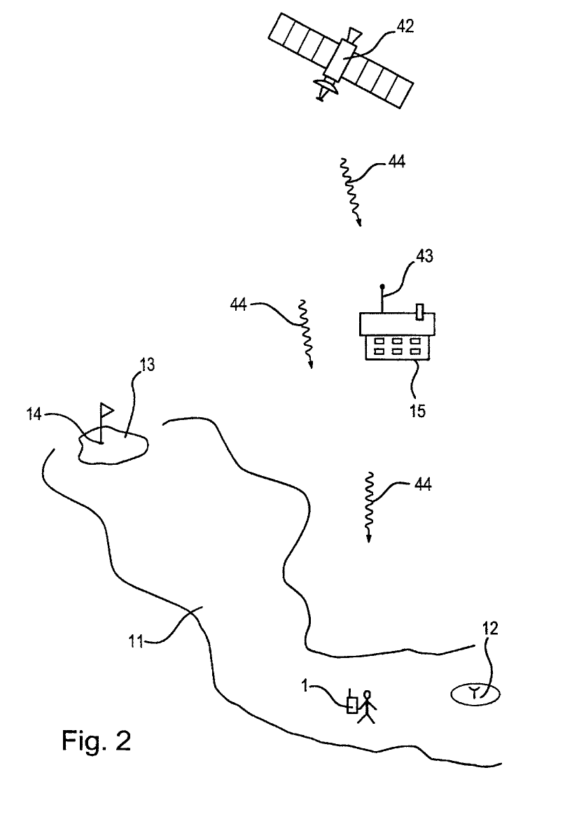

The GPS receiver 4 receives signals containing position information from an antenna 41. The signals belong to a global positioning system (GPS). FIG. 2 shows how the inventive golf navigation appliance interacts with the GPS and the surroundings. The golf course is represented, as an example, by a hole 11 having a tee 12 and a target on a green 13 for the hole 11. The central unit 1 of the golf navigation appliance is located on the hole 11 close to the tee 12. The figure also shows a GPS satellite denoted by the reference numeral 42. It also shows an optional reference station 43 in a clubhouse 15, said reference station being required for carrying out differential GPS navigation. The position of the golf navigation appliance on the hole 11 of the golf course is determined by the GPS receiver 4 from radio signals 44 emitted by the GPS satellites 42 and possibly by the reference station 43. The golf navigation appliance's position determined in this way is transmitted to the arithmetic device 3 by the GPS receiver 4 as an absolute-position signal. If appropriate, a quality signal can additionally be transmitted which is a measure of the current accuracy of the GPS system's position determination.

The memory device 5 comprises an exchangeable memory module 51 and a permanently installed memory chip 52. The memory module 51 is preferably a read-only memory, such as an EPROM or EEPROM; this stores a digitized map of the golf course, which contains information about the holes 11, the tees 12 and the greens 13 for one or more golf courses. The map can also contain statements regarding the position of the pin 14 and statements relating to obstacles (not shown) such as areas of water, bunkers or areas of undergrowth. The map also includes height information if this is available. Expediently, the digitized golf course map is stored in the form of a vector diagram; this has the advantage over a simple bit-map diagram that it takes up less memory space and can be shown to any scale, i.e. any desired details of the digitized golf course map can be shown in arbitrarily selectable enlargement. In addition, a non-volatile area of the memory module 51 stores a sample game progression. This is expediently a game progression such as has been played on this golf course by a person with a model character, for example a golf instructor or a professional player. The sample game progression includes path information from a plurality of position data and also additional information, in particular shot data regarding the number of shots required, club types used and the shot distances attained with these. The memory chip 52 is a read/write memory storing one or more actual game progressions and other information from the arithmetic device 3.

The display device 6 shows information. This device is connected to the arithmetic device 3. It has a graphics capability, so that a selectable area of the digitized golf course map can be shown. In addition, the display device 6 shows the golf player's position ascertained by the arithmetic device 3 using absolute and relative position data. The display device 6 also shows the current actual game progression and, in a separate area, the distance and direction from the current position to the target on the hole being played. It also shows the number of shots required, the par for the hole and also the total number of shots needed for the round to date. It is also possible to show an auxiliary target cursor which the golf player can move over the displayed area of the golf course map, with the respective distance and direction from the current position to the auxiliary target being displayed. The display device 6 is arranged in a top area on the front of the main housing 2.

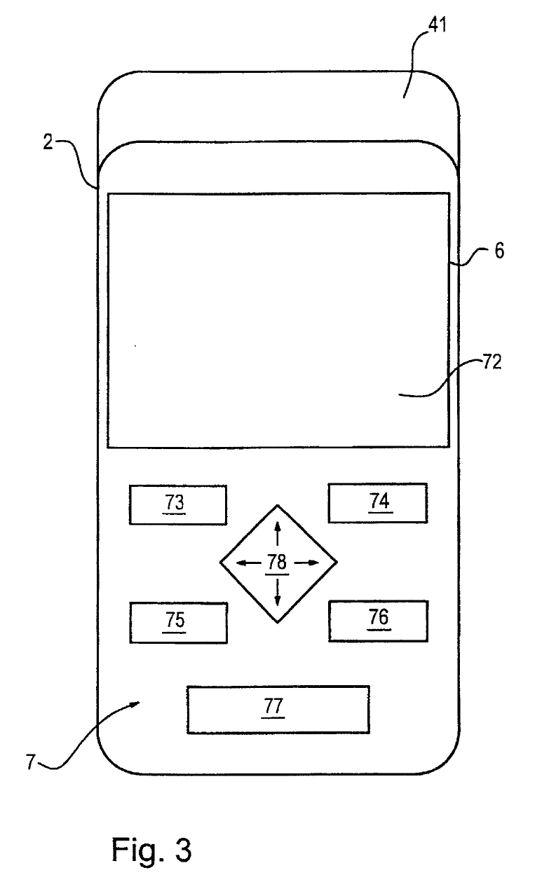

For the user to enter data, the input device 7 is provided. This comprises switches and buttons 71 which are arranged in a bottom area on the front of the main housing 2. In the exemplary embodiment shown in FIG. 3, this area includes a button 73 for retrieving the menu bar, a button 74 for confirmation, a button 75 for manually increasing the counter reading for player 1, a button 76 for manually increasing the counter reading for player 2, a button 77 for marking a position and an actuating rocker 78 with four directions (up, down, left and right) for selecting menu items. Preferably, a touch-input device 72 is also arranged on the display device 6 and can be used to determine the location of an auxiliary target in a manner which is intuitively easy to understand by touching an appropriate point on the displayed area of the golf course map. The touch-input device 72 can also be used for other input functions (e.g. marking the current ball position); on the other hand, it is not absolutely necessary, however, and the auxiliary target could also be entered using the actuating rocker 78.

The power supply device 8 comprises a storage battery 81 as an energy store which supplies electrical power to the devices of the central unit 1. To charge the storage battery 81, a charging circuit 82 is provided which draws electrical power from a solar cell 83 arranged on the outside of the main housing 2. In addition, a charging connection 84 for connecting an external power source is provided which is connected to the charging circuit 82.

The radio modem 9 is connected firstly to the arithmetic device 3 and secondly to an antenna (not shown). It is part of a transmission device for receiving measurement data from a physically separate sensor arrangement 100, 200. The radio modem 9 also transmits commands to the external sensor arrangement 100, 200.

Connected to the arithmetic device 3 is a data connection 31 for interchanging data with external data processing devices, for example a personal computer. By way of example, this data connection can be used for reading the actual game progressions from the memory device 5 and transmitting them for external evaluation. In addition, the digitized golf course map stored in the memory device 5 can be updated via the data connection 30. For this data connection 30, a serial data transmission method is preferably used, such as is known in the form of RS 232 C. The data connection 30 is generally a plug for connecting a data transmission cable (not shown), but it may just as well be an infrared data transmission connection.

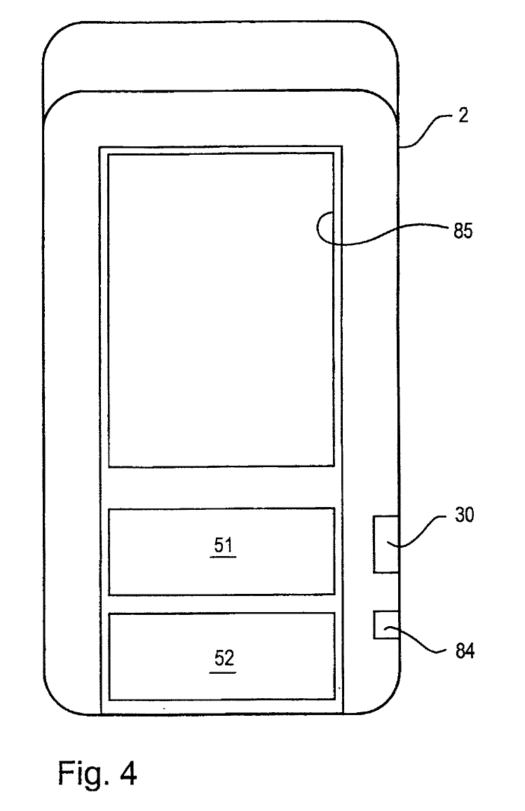

FIGS. 3 and 4 show the front and back of the main housing 2 of the central unit 1 of the golf navigation appliance. Arranged in the top area of the front is the display device 6, and in the bottom area the input device 7 is arranged on the front. The top edge of the golf navigation appliance holds the GPS antenna 41. The back of the main housing 2 has a compartment 85 for holding the storage battery 81 or batteries (not shown). The back also has insertion channels for inserting and removing the exchangeable memory module 51 and possibly the memory chip 52. Arranged on one longitudinal side of the main housing 2 is the data connection 30 and the power supply connection 84.

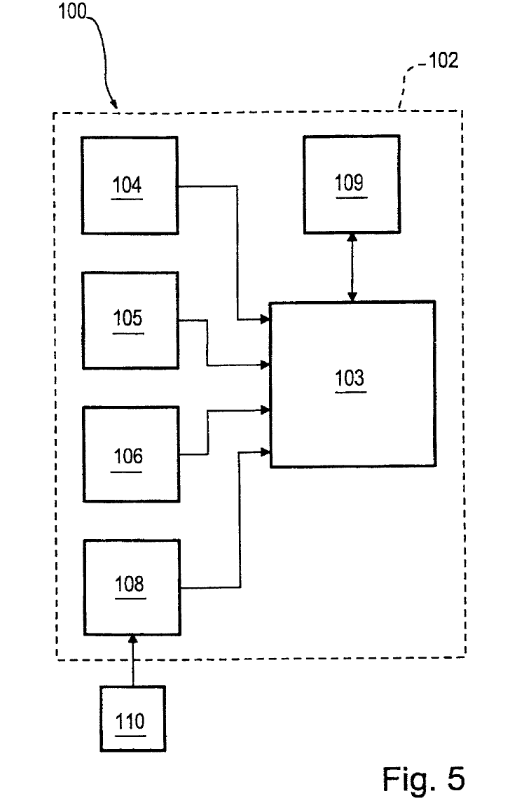

FIG. 5 shows an embodiment of the sensor device 100 arranged at a physically separate point. The external sensor arrangement 100 is attached to the body of the golf player in the area of his pelvis by means of a suitable holding device, for example a clip. A sensor housing 102 contains a second arithmetic device 103, an acceleration sensor 104, preferably having three axes with one axis pointing downward, a magnetometer 105, preferably having three axes, an inclinometer 106, preferably having two axes, a second power supply device 108 and a second radio modem 109. The second arithmetic device 103 has an analogue/digital converter which is connected to the acceleration sensor 104, to the magnetometer 105 and to the inclinometer 106. The second power supply device 108 is connected to the devices which need electrical power; to supply them, a second solar cell 110 is provided on the outside of the sensor housing 102. The second radio modem 109 transmits the measured signals processed by the second arithmetic device 103 to the radio modem 9 of the central unit 1; it is also used for receiving commands from the central unit 1.

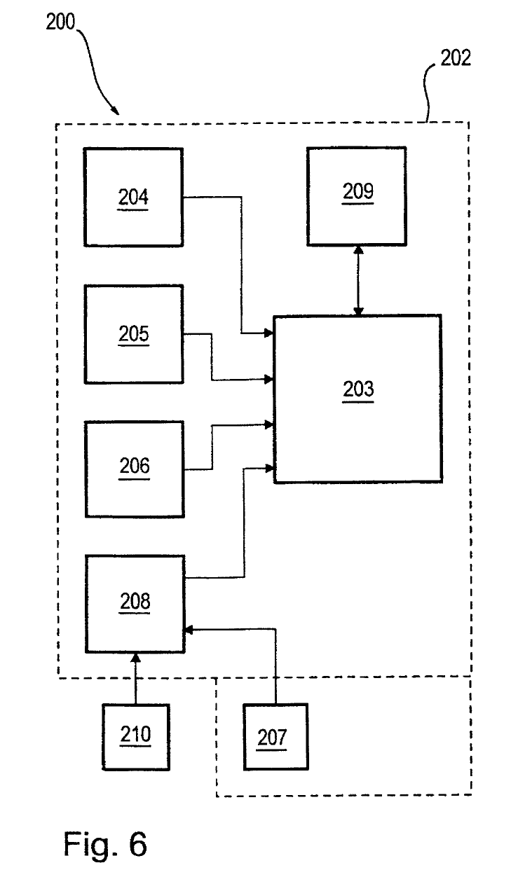

FIG. 6 shows a second exemplary embodiment of an external sensor arrangement 200. A sensor housing 202 contains a third arithmetic device 203, a rotation sensor 204, a second magnetometer 205, a second inclinometer 206, a third power supply device 208 and a third radio modem 209. The third arithmetic device 203 has an analogue/digital converter which is connected to the rotation sensor 204, to the second magnetometer 205 and to the second inclinometer 206. The third power supply device 208 is connected to the devices which need electrical power; to supply them, a third solar cell 210 is provided on the outside of the sensor housing 202. The third radio modem 209 transmits the measured signals processed by the third arithmetic device 203 to the radio modem 9 of the central unit 1; it is also used for receiving commands from the central unit 1. The external sensor arrangement 200 is attached to a golf vehicle or to a golf trolley, with the rotation sensor 204 being connected to one of the wheels thereof. In addition, a dynamo 207 is connected to one of the wheels and is connected to the third power supply device 208 in order to provide it with additional power. The rotation sensor 204 and the dynamo 207 can be fitted together, with the rotation sensor 204 preferably using signals from the dynamo 207.

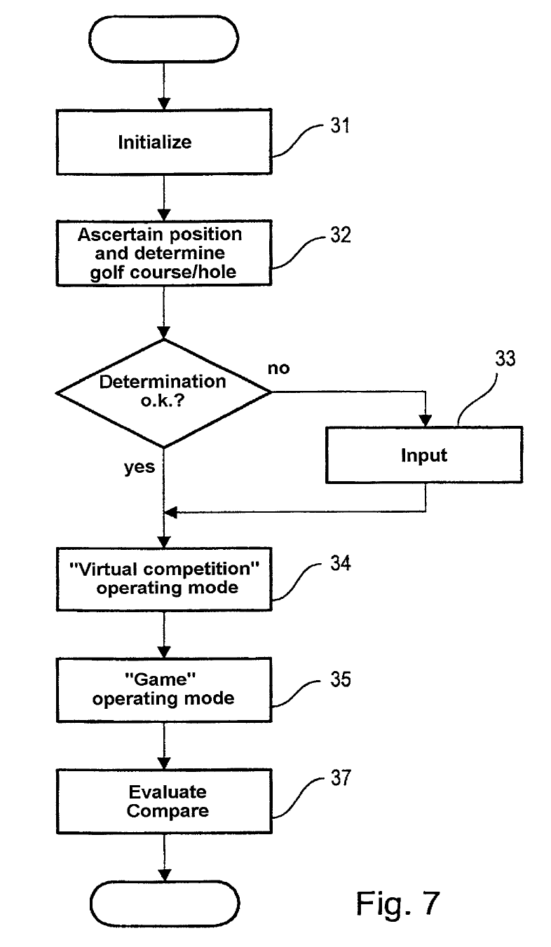

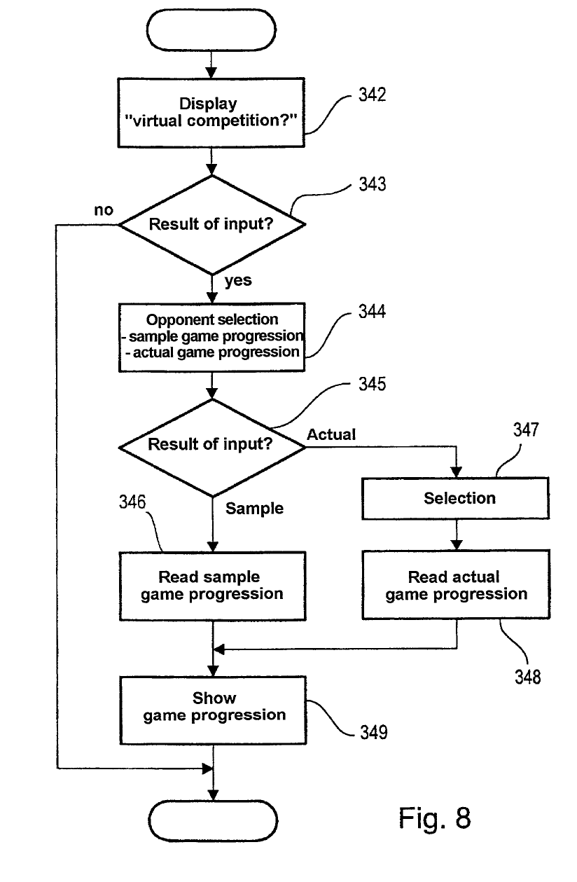

The golf navigation appliance is used in the following manner (FIG. 7): before starting it up, a memory module containing the sample game progression and the digitized golf course map needs to be inserted. After turning on, initialization 31 takes place, in the course of which the data for the digitized golf course map are read from the memory device 5 into the arithmetic device 3. After a short time, position data from the GPS receiver 4 are available. These position data can then be used to initialize the start of play, i.e. the golf course and the hole to be played can be determined 32; should this not be possible, for example on account of a lack of position information, a user input 33 can also be made. The display device 6 shows a detail from the digitized golf course map; generally, the hole 11 being played is shown. The start of the actual game progression and data capture is the associated tee 12 for the hole 11. The display device 6 offers a selection option 342 for a “virtual competition” operating mode at 34. There is then a request 343 for an input by the user. If this input is negative, the procedure continues in a “game” operating mode 35; if it is positive, the procedure continues in the “virtual competition” operating mode with the following steps, shown in FIG. 8: a selection menu for the opponent selection is displayed 344, which menu offers the sample game progression or a previously stored actual game progression. An input is requested 345 from the user. If the former alternative has been selected, then the sample game progression is read 346 from the exchangeable memory module 51 and the procedure continues by showing 349 the game progression which has been read. If the second alternative is selected, then, provided that a plurality of actual game progressions are stored, these are shown 347 and there is a request for a selection therefrom. The selected actual game progression is read 348 from the memory chip 52, and the method continues by showing 349 the game progression. It then continues in the “game” operating mode 35.

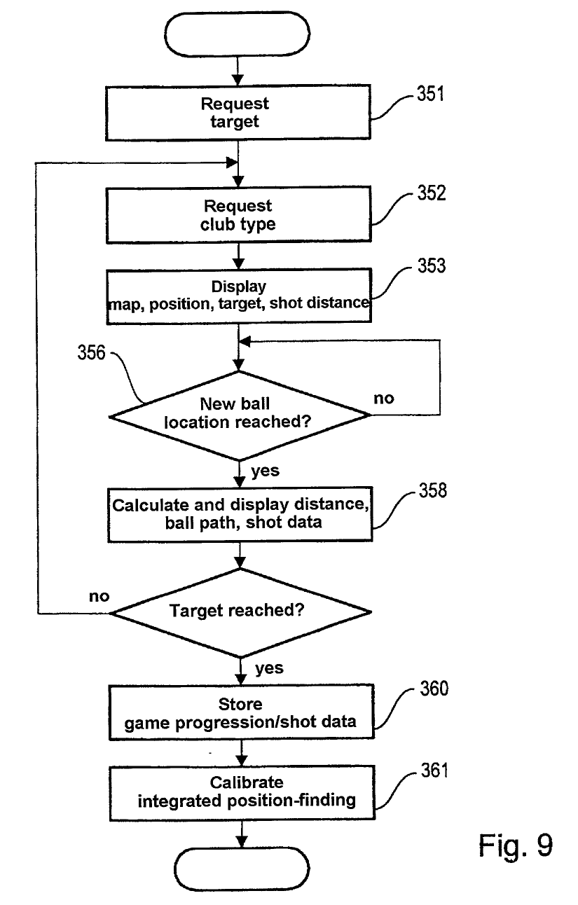

In the “game” operating mode 35 shown in FIG. 9, there is a request 351 for the target. Generally, this is the pin 14 on the hole 11 being played; instead of a user input, it is therefore also possible to ascertain a main focus of the surface of the green 13 using the digitized golf course map and to take this as the target. There is then a request 352 for the club type. This is only required if data collections relating to club type are to be created and statistics dependent on the club type are to be produced. The target, a predicted shot distance and the appliance's own position on the selected area of the golf course map are then displayed 353 on the display device 6. Showing the forecast shot distances allows the golf player to assess whether the selected club type is appropriate or rather inappropriate, for example because the ball can be expected to land in the area of an obstacle. To simplify the golf player's assessment, he can use the touch-input apparatus 72 or the actuating rocker 74 to determine an auxiliary target on the displayed area of the golf course map, for which the distance and direction from the current position are then displayed. If, for example, an area of water to be crossed lies ahead of the golf player, then he just needs to touch the back edge of the area of water seen from his perspective on the touch-input device 72, and the central unit 1 ascertains and displays the distance and direction from the current position to the selected point; on the basis of this information, the golf player can select an appropriate club type. In this way, he can also determine the distance to particular points in the sample game progression, which greatly simplifies imitation of the sample game progression. After teeing off, the golf player walks to the new location of the golf ball and marks this point by pressing 356 the appropriate button 77. The new position of the golf ball is ascertained and stored. In addition, in a next step 358, the distance from the tee is calculated and displayed, the path of the ball is stored and displayed, the number of shots is increased by one and the shot data are stored. After a request 359 to determine whether the target (pin) has been reached, the process is repeated from the request 352 for the club type until the pin has finally been reached. That part of the actual game progression which is ascertained for this hole is stored 360 with the path data and shot data. The integrated position-finding is then calibrated 361. The “game” operating mode 35 is repeated for all the holes in a game. After the end of the game, data capture is complete and the procedure then continues in an “evaluation and comparison” operating mode 37.

To determine the position, the arithmetic device 3 uses position data from the GPS receiver 4 as absolute position data and measurement signals from the external sensor arrangement 100 which are transmitted by the radio modems 9, 109. Alternatively, measurement signals from the external sensor arrangement 200 can also be used via the radio modem 209. The arithmetic device 3 uses the signals coming from the external sensor arrangement 100 or 200 to perform integrated navigation, i.e. it ascertains relative position statements. The starting position used is an absolute position statement; this can come both from the navigation device 4 or from the memory device 5 having the digitized golf course map, if a position stored therein, such as the tee, is used as the starting point. The absolute position statements ascertained by the GPS receiver 4 and the relative position statements calculated using integrated navigation are used by the arithmetic device 3 to ascertain the current position; for this purpose, it uses data merging techniques, as are known per se. Thus, for example, in the event of GPS navigation being unavailable, the current position is ascertained by integrated navigation on the basis of the last GPS position measured. It is not absolutely necessary for integrated navigation to be performed in the arithmetic device 3 in order to calculate the relative position; it may also be performed in the external arithmetic device 103, 203. This has the advantage that only the position data and not the sensors' measurement data, which require more bandwidth, need to be transmitted via the radio modems 9, 109, 209. This also makes position determination more reliable, since undetected transmission interference when transmitting measurement data results in incorrect measurement and hence in an incorrectly determined position, whereas transmission interference when transmitting a position is easier to detect.

The memory device 5 is provided with a plurality of areas called data pools. By way of example, there is a day data pool, a personal total data pool and a course-related data pool. The day data pool is used for documentation, i.e. it stores the current actual game progression for qualitative evaluation by means of display on the display device 6. It stores, in particular, the shot data with the club types and the positions of the tees. The personal total data pool is used for analysis and prediction. For this purpose, a large number of shot data are stored for a player. From these data, random samples can be drawn for evaluation and prediction. This data pool contains, in particular, the shot lengths attained with one club type in order to predict the shot distance which can be expected with this club type. Expediently, the shot lengths used for the prediction are corrected by influence of wind. This can be done by correcting the measured shot length according to influence of wind and storing it thus or by storing the measured shot length together with the wind data, so that the correction is made only upon the prediction. The course-related data pool is used for documentation, i.e. for documenting all the games on a particular course in a way which then permits the game progression to be shown graphically on the display. Among other things, the number of shots per hole and round and also the shot length on the basis of the club type used are stored.

The data pools are evaluated in the following manner: the day data pool permits count evaluation, i.e. the number of shots for a round, evaluation of a result on the basis of the respective counting method (gross result) and evaluation of a result on the basis of a handicap (net result). The net result is calculated by deducting the handicap from the gross result. In some cases, other counting methods are used, particularly in tournaments. The personal total data pool is used to form statistical characteristic quantities, such as mean value, standard deviation, variance, maximum and minimum values, for the shot distance on the basis of the club type. In addition, the statistical prediction reliability is determined, i.e. the area of confidence for the prediction. The course-related data pool can be used to retrieve and show the best and worst games for the entire course and/or for individual holes. In addition, a course statistic can be produced, for example with average values for the shot length per hole or maximum and minimum shot length per hole and round. It is also possible to predict the shot length, and this prediction can also be referred to as “inverse shot length calculation”. On the basis of the distance to the target or to an auxiliary target, a club recommendation is ascertained and shown on the display device 6, taking into account the shot distance which can be expected with the individual club types.

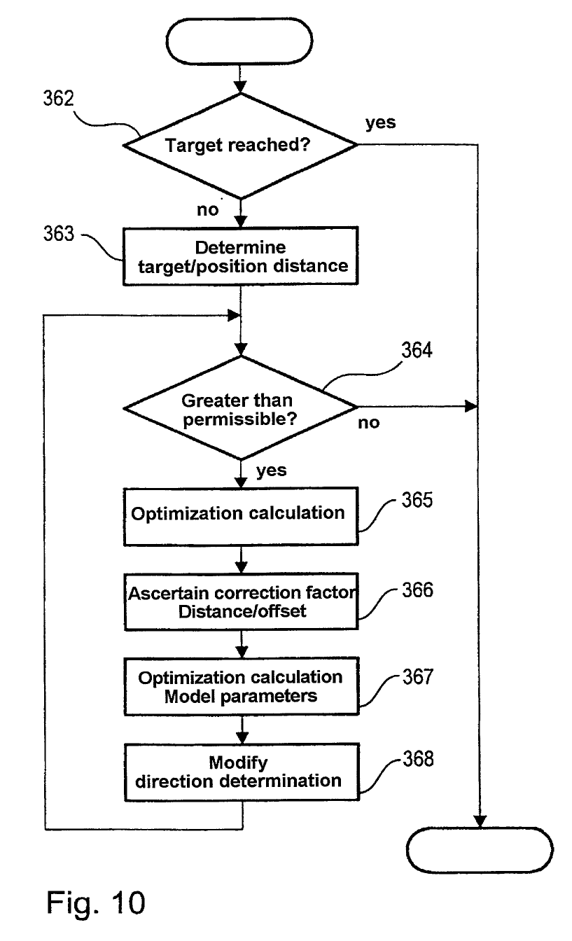

FIG. 10 shows calibration of the integrated navigation. In a first step 362, the procedure detects whether the target on a hole 13, that is to say normally the pin 14, has been reached. This can be done automatically by comparing the current position with the known position for the pin 14, or can be verified by requesting a user input. In a subsequent step 363, the distance between the target's position known from the digitized golf course map and the current position is determined. In a subsequent step 364, the procedure determines whether the distance is greater than a permissible maximum discrepancy. If this is the case, then an optimization calculation is performed in a subsequent step 365, this calculation being used to ascertain 366 correction factors for the distance and to ascertain an offset for the magnetometer 105, 205. An optimization calculation 367 is then performed to modify parameters for a model and to modify polynomial coefficients. The offset for the compass sensor 205 is also used to modify the direction determination 368. Optimization is expedient because integrated position-finding produces errors which add up over time to give growing divergences from the true location. The starting point for integrated position-finding is the tee 12 on a hole 11. The end for integrated position-finding is the pin 14 on the same hole 11. The positions of the two points are known from the digital map. The actual game progression corresponds to an uncertain polygonal move from the tee 12 to the pin 14. If errors have arisen in the calculation, then the polygonal move does not end at the pin 14. This error is minimized on the basis of magnitude and direction in an optimization calculation. Parameters for the optimization may be as follows: errors in the pace length estimation, errors in the compass. Examples of advantageous methods are as follows: last square, Rosenbrock's optimizer. The two stated parameters are varied until the error assumes a minimum. The resultant variations in the pace length and the walking direction are incorporated into the rest of the integrated position-finding.

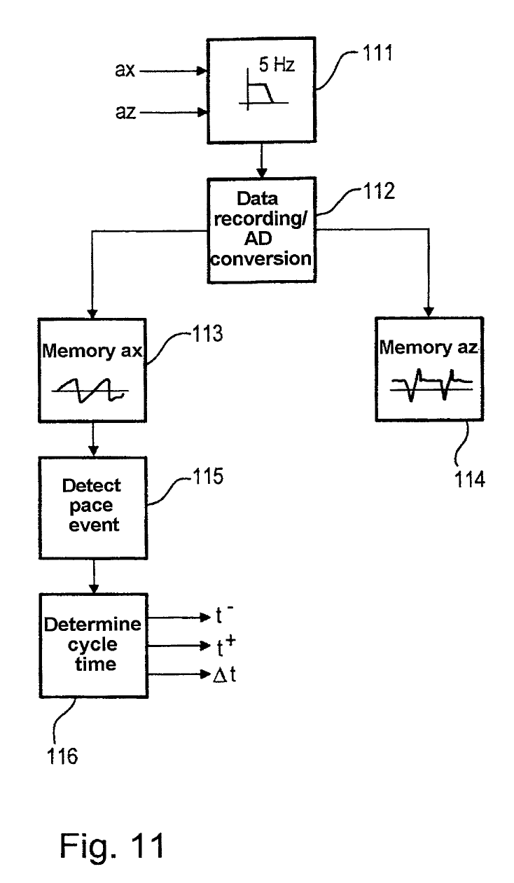

The way in which the walk-estimator works is shown in FIGS. 11 to 15. The calculations and steps explained below are performed by the arithmetic device 3 in order to ascertain the distance covered on foot and the walking speed from the acceleration data measured by the external sensor arrangement 100 using the acceleration sensor 104. The calculations can also be performed in the external second arithmetic device 103. The values ax for the accelerations in the horizontal direction and az in the vertical direction are recorded, are supplied to an anti-aliasing filter 111 having a corner frequency of 5 Hz or above, and are then subjected to analogue/digital conversion 112 using a sample frequency of, preferably, at least 20 Hz. The acceleration sensor 104 preferably has a coordinate system which is fixed on the body of the user; however, the use of a coordinate system fixed to the ground should not be ruled out. The initial values are stored in a respective dedicated memory area 113, 114 for ax and az using a frame time of one second. To detect a pace event 115, the stored acceleration values for, preferably, ax are searched for an extreme, for example representing placement of the left heel, then a subsequent extreme is sought, which represents placement of the right heel in the chosen example, and finally a further extreme is sought, which again represents placement of the left heel. This completes the cycle for the pace by a leg, in the chosen example the left leg. Calculation of the time difference between the instants for the successive placement of a heel determines the cycle time 116.

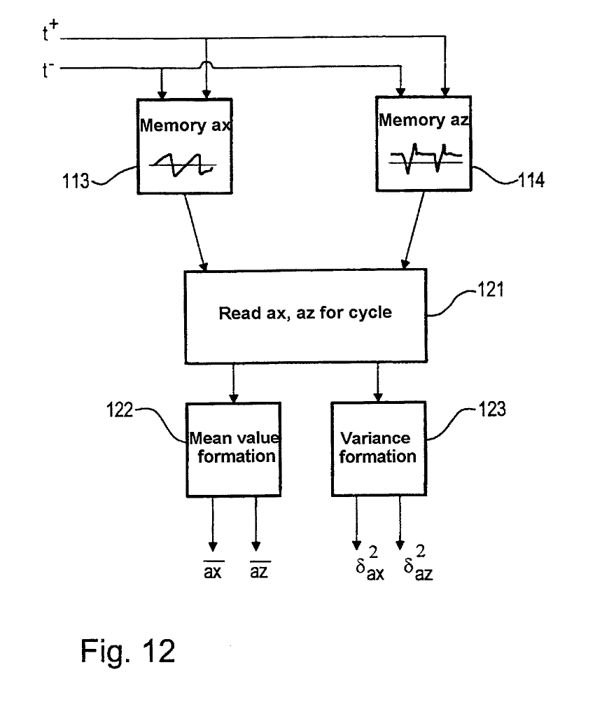

FIG. 12 shows how the cycle time is used to ascertain further statistical quantities. For the duration of a cycle time, acceleration values ax, az are read 121 from the associated memory areas 113, 114. By forming mean values 122 for the read acceleration values ax, az independently in each case, mean values for the acceleration ax and for the acceleration az are ascertained. Forming variances 123 over the cycle time ascertains variances in the acceleration values ax and az.

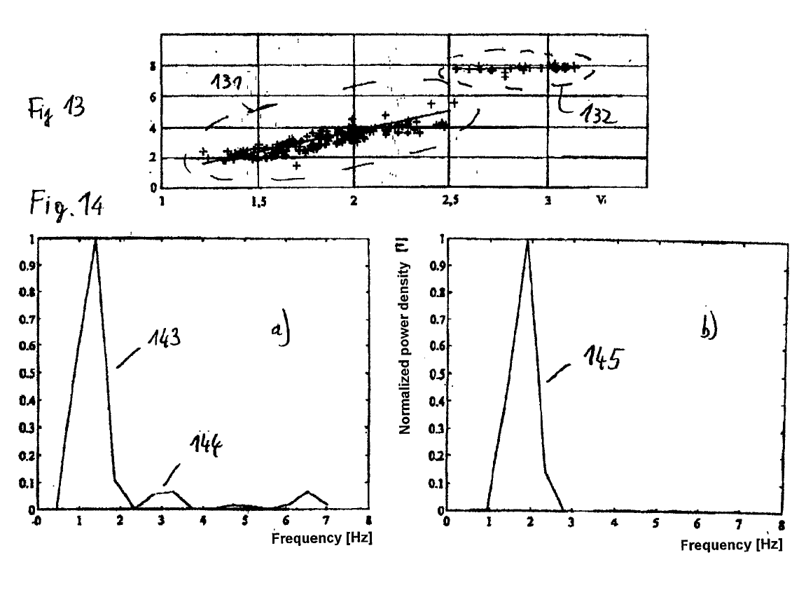

The text below describes detection of running or walking. One parameter used is the variance in the acceleration values az. The variance's cyclical values over one walking pace are smoothed using a low-pass filter. The values are stored, so that past values are available for the variance in the acceleration values. The respective current value for the variance in the acceleration az is compared with the past values; a rapid rise in the variance value switches a binary selection signal, which indicates a state of walking or running, to a HIGH state, and a rapid drop switches it to a LOW state, otherwise the state of the signal remains unchanged. It is also possible to provide a signal or signals which indicates a change of state. The HIGH state of the signal can deactivate at least part of a model for the walk-estimator, in order thus to prevent incorrect estimations by the model formed only to estimate walking motions. Preferably, this is done by applying the selection signal as an inhibitor signal for the optimization calculation 367. If a model is available for estimating running motions (run-estimator), this signal can be used to change over to the run-estimator. FIG. 13 shows examples of the variances in the acceleration az over the speed v for walking 131 and running 132.

Running or walking can also be detected by determining the value range for the acceleration values az. To this end, the minimum and maximum values for the acceleration az are smoothed, preferably using a low-pass filter, and the respective current acceleration values are compared with the smoothed values. If the range lies within an area typical for walking, the selection signal is put into its LOW state; if the range lies outside the area, the selection signal is put into a HIGH state. Typical limit values for the ranges are −12 to −5 m/s² at a speed of 1.8 m/s for walking, and −16 to 0 m/s² at a speed of 3.0 m/s for running.

In addition, running or walking can be detected by determining the power density spectrum for the vertical acceleration az. The power density spectrum is calculated using methods known per se. In the power density spectrum, besides a primary maximum for walking, significant ancillary maxima occur; when running, they largely disappear. The parameter used for motion of the pelvis can be the acceleration az. In the power density spectrum, the primary maximum is ascertained and a first-order ancillary maximum is sought. Such an ancillary maximum is regarded as being present if its value reaches 2% of the value of the primary maximum. If this ancillary maximum is not present, the selection signal is put into its HIGH state. Methods for calculating the power density spectrum are known; inexpensive chips are also available in which such a calculation is implemented. A tried-and-tested method is to provide at least 64 discrete points for calculating the power density spectrum, given a sampling frequency of 30 Hz; depending on the demands on the spectral resolution, the number of discrete points can be increased or reduced. FIGS. 14a and 14b show examples of a normalized power density spectrum for walking 143 (with ancillary maximum 144) and for running 145.

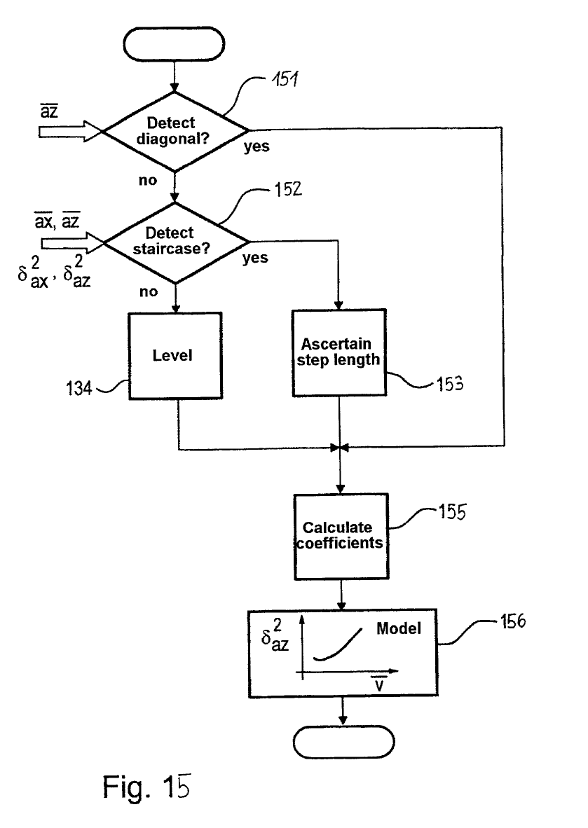

FIG. 15 shows the modelling for the walk-estimator. Mean value data for the acceleration az are processed in a diagonal-recognition step 151 and influence coefficients 155 of an estimation model 156. The diagonal-recognition step 151 uses the correlation of the mean-value data for the acceleration az using a polynomial rule, preferably at least of 2nd order, from a regression. If no diagonals are recognized, variance in and mean-value data for the accelerations ax, az are processed in a staircase-recognition step 152, and a fixed step length 153 is ascertained in the process. If a staircase is not recognized, level ground is assumed 154 and the coefficients 85 are determined in a further step. These are coefficients for the estimation model on which the model calculation step 156 is based, for which coefficients a mean walking speed is ascertained from variance data for the acceleration az. The walking speed thus ascertained and the previously ascertained cycle time can be used to ascertain the distance walked. By multiplying the mean walking speed by the cycle duration, it is possible to ascertain the pace length for a leg; an average pace length is calculated by averaging the pace lengths for both legs. By adding up the pace lengths, the distance walked is calculated. If it has been calculated in the external second arithmetic device 103, the distance walked 3 is transmitted using the radio modems 9, 109 to the arithmetic device 3 for further processing during relative position determination using integrated navigation.

The modelling described with reference to FIG. 15 is one good option from several. A simple, albeit somewhat less accurate, alternative has the following steps: first, the duration of a pace is determined, e.g. from accelerations; it can also be determined from the noise in the inclination sensor, however, since the inclination sensor has intrinsic dynamics and reacts to the motions of the body. Secondly, the pace length is ascertained from a linear model. This is equivalent to the polynomial model in FIG. 15, with the cycle duration being used as parameter. Although this alternative is not optimum in terms of the results obtained, it is generally sufficiently accurate and less complex, since sensors can be obviated. In this context, it is possible, in particular, to use a 1st-order polynomial, for example a linear regression line.

Suitable input parameters for the polynomial of the walk-estimator are, in particular (with decreasing quality), the az variance, the cycle duration, the ax variance, the ax maximum value, the variance in an acceleration ay measured horizontally, transversely with respect to the direction of walking, and the maximum value of az.

A further processing step (not shown) can also be used to determine a shot event from the stored acceleration values ax, az, i.e. the time at which the golf player plays a shot. In principle, detection of the shot event follows a similar course to detection of a pace event, which is shown in FIG. 11; however, it is also possible to provide statistical methods which are more complex than simple maximum determination. The position currently adopted by the golf player at the instant of the shot event can then be stored as the shot location in the memory device and the corresponding data pools, without the need for input by the golf player on the input device 7, since the shot location detected in this manner is generally identical to the new ball location from the previous shot, which was marked beforehand by pressing the button 77. This eliminates the pressing of a button for each shot or when the new ball position is reached, which firstly simplifies use of the golf navigation appliance and secondly achieves a greater level of reliability, in particular for shot counting.

Polynomial rules for determining parameters for walking, such as speed, and for obtaining measured values are known to the person skilled in the art and, by way of example, are described in

Cavagna, G. A. and Franzetti, P., The determinants of the step frequency in walking humans, H. Physiol., Vol. 373, pp. 235-242, 1986;

Inman, V. T. Ralston, H. J., Todd, F., Human Walking, Williams & Wilkins, Baltimore/London, 1981;

Kirtley, C., Whittle, M. W., Influence of walking speed on gait parameters, J. Biomed. Eng., Vol. 7, pp. 282-288, 1985; Jefferson, R. J., Morris, J. R., Accelerometry - a technique for the measurement of human body movements, J. Biomechanics, Vol. 6, pp. 729-736, 1973.

The explanation given above for the walk-estimator also applies in an appropriate context for the run-estimator, if present.

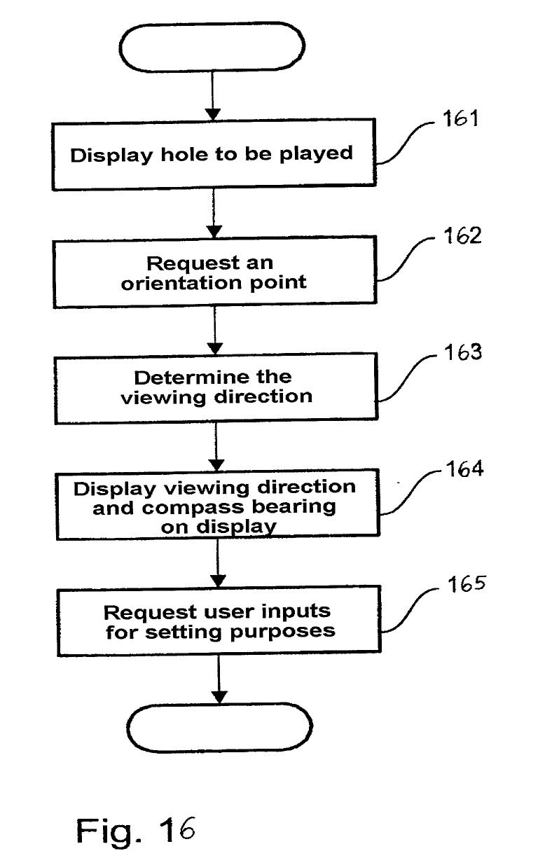

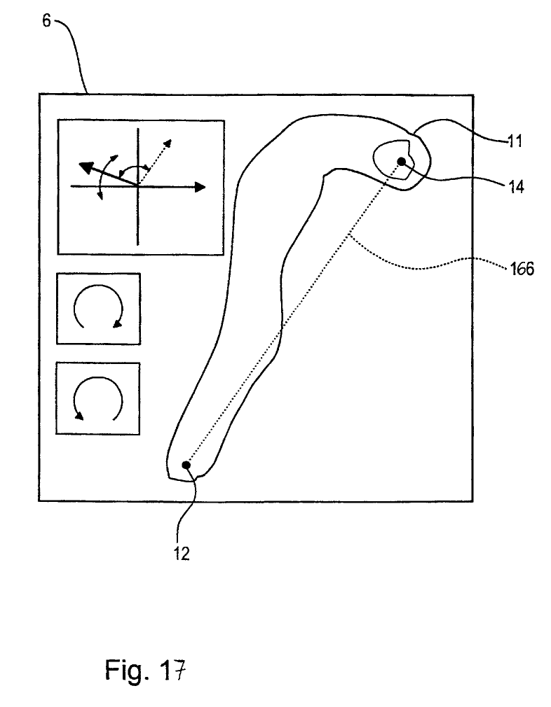

FIG. 16 shows manual calibration of the compass. This is necessary because the compass is usually seated permanently in the housing for the sensor clip 100, for example. Such a clip can be attached to any point on the user's belt. For this reason, the walking direction of the user and the sensor axis of the compass generally do not match. For the user to be able to carry out calibration, the calibration method described below is provided. Expediently, it is called up using a menu item in the initialization step 31. First, the hole 11 to be played is shown 161 on the display device 6. There is then a request 162 for an orientation point, which is a distinctive point visible from the tee; generally, this is the flag at the pin 14 for the hole 11 to be played. The request 162 involves marking the selected orientation point on the display device 6 using the actuating rocker 78. After the user has rotated his body in the direction of this orientation point, the viewing direction 166 is determined 163 from the tee, which is known from the map, and from the marked orientation point. Expediently, the display device 6 shows 164 the viewing direction 166 and the compass bearing. User inputs are then requested 165 which are used to rotate the compass bearing shown to cover the viewing direction 166. The angle of rotation required for this purpose corresponds to the compass error. This value is stored and used for correcting the compass values in the course of integrated position-finding. A display for the calibration mode on the display device 6 is shown in FIG. 17.

1. A portable golf navigation appliance for determining and indicating a position of a golf player on a golf course comprising a navigation device, a memory device, an input device and a display device which are connected to an arithmetic device, the navigation device comprising a relative-position determination device which comprises a first motion sensor producing measurement data and a model-based estimator for a distance covered on foot which is designed to process the measurement data in a biomechanical model.

2. The portable appliance according to claim 1, wherein the first motion sensor is an acceleration sensor.

3. The portable appliance according to claim 2, wherein the acceleration sensor is designed to measure vertical acceleration.

4. The portable appliance according to claim 2, wherein the acceleration sensor is set up to measure two directions of acceleration.

5. The portable appliance according to claim 1 or 2, wherein the motion sensor is arranged in the area of the golf player's pelvis.

6. The portable appliance according to claim 1, wherein the relative-position determination device further comprises a second motion sensor, which is arranged at a physically separate point from the first motion sensor and includes a wireless transmission device.

7. The portable appliance according to claim 1, wherein the navigation device further comprises an absolute-position determination device.

8. The portable appliance according to claim 7, wherein the absolute-position determination device provided is a GPS receiver.

9. The portable appliance according to claim 1, wherein the memory device stores a sample game progression or a digitized golf course map.

10. The portable appliance according to claim 1, wherein the memory device comprises an exchangeable memory module which stores the digitized golf course map or the sample game progression.

11. The portable appliance according to claim 9, further comprising a comparison device which compares an actual game progression with another game progression or with the sample game progression.

12. A method for navigation in a golf game, comprising:
reading an area of a digital golf course map from a memory device,
offering a selection option between at least one sample game progression or an actual game progression stored in the memory device,
reading a sample game progression from the memory device,
determining a current position using a navigation device,
storing an actual game progression in the memory device, and
displaying the actual game progression or comparing the actual game progression with a selected game progression.

13. The method for navigating according to claim 12, further comprising requesting a club type.

14. The method for navigating according to claim 12, further comprising requesting a number of golf players and storing respective actual game progressions in an associated area of the memory device.

15. The method for navigating according to claim 12, comprising:
requesting an orientation point,
determining a direction to the orientation point,
determining a direction by a compass device of a user looking toward the orientation point,
ascertaining an angle difference between the directions to the orientation point and the direction of the user, and
storing the angle difference in order to correct the measured values of the compass device.

16. The method for navigating according to claim 12, further comprising
ascertaining and storing a starting point and an ending point for at least part of a game progression using relative or absolute position data,
determining a difference from a known position of the ending point, and
modifying parameters for integrated navigation based on the determining of the difference.

17. A method for navigating using a relative-position determination device, comprising:
measuring acceleration values using a motion sensor arranged on a pedestrian user,
storing the acceleration values over a time period, and
calculating walking speed or distance walked for the pedestrian user using a biomechanical estimation model.

18. The method for navigating according to claim 17, further comprising measuring longitudinal and vertical accelerations.

19. The method for navigating according to claim 17 or 18, comprising using a first polynomial rule with a correlation of variances in the acceleration values for calculating the walking speed or distance walked.

20. The method for navigating according to claim 17 or 18, comprising a first polynomial rule with determination of the pace duration and pace length for calculating the walking speed or distance walked, and measuring accelerations in order to determine pace duration.

21. The method for navigating according to claim 18, comprising detecting a running or walking state by calculating variances in the acceleration values over cycle time, and comparing the variances with previous variances.

22. The method for navigating according to claim 17, comprising calculating ranges of the acceleration values.

23. The method for navigating according to claim 17, comprising calculating a power density spectrum for an acceleration and determining whether significant ancillary maxima are available.

24. The method for navigating according to claim 17, further comprising detecting a shot event from the acceleration values in order to determine a shot location.

25. A portable navigation appliance for determining and indicating the position of a pedestrian comprising a navigation device, a memory device, an input device and a display device which are connected to an arithmetic device, the navigation device comprising a relative-position determination device which comprises a first motion sensor producing measurement data and a model-based estimator for a distance covered on foot which is designed to process the measurement data in a biomechanical model.

26. The portable appliance according to claim 25, wherein the first motion sensor is an acceleration sensor.

27. The portable appliance according to claim 26, wherein the acceleration sensor is designed to measure vertical acceleration.

28. The portable appliance according to claim 26, wherein the acceleration sensor is set up to measure two directions of acceleration.

29. The portable appliance according to claim 25, comprising a detector device for a walking or running state.
